(19) United States
(12) Patent Application Publication
(10) Pub. No.: US 2013/0298663 A1
(43) Pub. Date: Nov. 14, 2013

(54) FLOW MEASUREMENT

(71) Applicant: Christian Robert Maurice Singfield, Auchenflower (AU)

(72) Inventor: Christian Robert Maurice Singfield, Auchenflower (AU)

(73) Assignee: Mezurx Pty Ltd, Auchenflower (AU)

(21) Appl. No.: 13/883,939

(22) PCT Filed: Nov. 8, 2011
(86) PCT No.: PCT/AU2011/001424

§ 371 Date: Jul. 29, 2013

(30) Foreign Application Priority Data
Nov. 8, 2010 (AU) 2010904960
Sep. 14, 2011 (AU) 2011903772

(51) Int. Cl. G01F 1/44; G01F 1/84

(52) U.S. Cl. CPC G01F 1/44; G01F 1/8454
USPC 73/152.34; 73/861.354

(57) ABSTRACT

A liquid (6) flows through a wedge meter (13). The density of the liquid (6) is measured with a Coriolis meter (14). Density as measured by the Coriolis meter (14) is used in calculating the volume flow of fluid (6) through the wedge meter (13).

### FIELD OF THE INVENTION

The present invention relates to the field of fluids handling, and is particularly applicable to the handling of slurries such as drilling muds. Although the present invention is described with reference to the use of drilling muds used in the course of drilling bore holes such as oil and gas wells, it is to be understood that the invention is not limited to the field of drilling muds.

### BACKGROUND OF THE INVENTION

Drilling muds are usually water-based, but they can be based on other liquids such as synthetic oils. Additives arc mixed with the liquid base. Common additives to water-based drilling muds include solids such as barite, chalk (calcium carbonate) and haematite. It is required that these added solids be homogeneously mixed with the liquid base, and that the homogeneity be maintained.

The physical and chemical characteristics of drilling mud also vary during the process of drilling Depending on the geology at the depth of the drill bit, it may be necessary for the driller to actively vary any one or more of the density, viscosity, pH, or other chemical or physical property of the drilling mud. In the oil industry, when drilling a borehole, the drilling muds used during the life-cycle of a single borehole could begin with water, then move to a water based mud, then move from the water-based mud to a synthetic oil based mud. These drilling muds have a complex range of physical characteristics and the characteristics required at any particular stage of the drilling process vary during the drilling life-cycle. Physical or chemical characteristics of the mud may also vary depending on events which are not under the control of the driller. The invasion of petroleum products into the bore hole is such an event, and will cause a “kick” or impulse change in the characteristics of the drilling mud, causing sudden variations in, for example, the density and/or viscosity of the mud.

It is also important for the driller to monitor volumetric flows of the drilling mud.

FIG. 1 is a block schematic representation of apparatus 1 that is typically currently in use for monitoring volumetric flows of drilling mud. There is a supply of drilling mud 6 in surface tanks 2. The mud 6 in the tank 2 is kept in a relatively homogeneous state using a mixer 3 which is driven by an electric motor 4. Mud 6 is drawn off from the tank 2 by the pump 8 which is connected to the tank 2 by pipe 7. Mud flows from the outlet 9 of the pump 8 into the bore hole (which is not illustrated in the drawing). Mud which flows out of the bore hole is subjected to various treatments (which are not illustrated in the drawing) and then returned to the tank 2.

The pump 8 is a positive displacement pump. Such pumps generally comprise multiple cylinders with reciprocating pistons to even out fluctuations in pressure and flow. It is necessary to use a positive displacement pump because centrifugal pumps cannot deliver the high pressure required but positive displacement pumps can.

The flow of mud 6 into the pump 8 is controlled by inlet and outlet valves (which are not illustrated in the drawings.) To monitor the volume of 6 that is moved by the pump 8, the number of piston strokes are counted. This counting is generally done by mounting a proximity detector on the pump housing and the proximity detector detects the magnetic field of the moving piston. On the basis that the cross-sectional area and the stroke length of the piston pump 8 are known, the flow rate from the pump 8 is the product of the stroke rate, stroke length and pump cross-sectional area. However, this calculation is also based on the assumption that there is no back-leakage past the inlet valves of the pump and that there is perfect sealing between the piston and the pump cylinder. These assumptions may well be true when the pump is new or fitted with new parts, but may not be true when the pump is worn or in need of repair. These pumps are high-maintenance and require frequent re-builds of the working parts.

Although it is not illustrated in FIG. 1, the flow of mud 6 in such an arrangement is generally measured using a pressure differential flow meter. (A pressure differential flow meter is also known as a Venturi meter.) That is, it is a device which utilizes the pressure differential across a flow restriction to determine the flow rate of fluid. Wedge meters are a particularly suitable form of pressure differential meter for abrasive slurries such as drilling muds because the restriction is in the form of a wedge-shaped indentation in the wall of the pipe that is carrying the fluid. Such a restriction is less susceptible to wear and damage than is the orifice-in-a-plate type of restriction that is traditionally used in Venturi-effect flow meters. Such wear and damage affects the accuracy of the meter. As a practical matter, if a wedge meter is designed to work across the full range of densities of drilling mud, then it would have poor accuracy.

### SUMMARY OF THE INVENTION

In contrast, in one aspect, embodiments of the present invention provide a method of measuring the volume flow rate of a liquid, comprising:
providing a flow of the liquid;
tapping off a portion of the flow of liquid and using a Coriolis meter to measure the density of that portion of the flow of liquid;
passing at least part of the flow of liquid through a Venturi meter, and using the density of the liquid as measured by the Coriolis meter in calculating the volume flow rate of fluid through the Venturi meter.

It is preferred that the Venturi meter is a wedge meter.

It is preferred that the flow of liquid is supplied by a centrifugal pump.

It is preferred that at least part of the liquid flows through a positive displacement pump.

It is preferred that the method further comprises the step of using:
the volume flow rate through the Venturi meter; and
the volume flow rate through the Coriolis meter,

to calculate the volume flow rate through the positive displacement pump.

It is preferred that the method further comprises:
counting the pump strokes of the positive displacement pump;
using the count of pump strokes to calculate the volume flow rate through the positive displacement pump; and
comparing:
   the volume flow rate through the positive displacement pump as calculated by counting the pump strokes; with
   the volume flow rate through the positive displacement pump as calculated by using the volume flow rate through the Coriolis meter and the Venturi meter.

It is preferred that the liquid is a slurry. It is further preferred that the slurry is a drilling mud.

In another aspect, embodiments of the invention provide apparatus for measuring the volume flow rate of a flow of liquid, comprising in combination:
a Coriolis meter which is adapted to measure the density of a portion of the flow of liquid;
a Venturi meter which is adapted to measure a pressure differential which is generated by the flow of at least a portion of the liquid through it and means which is adapted to use:
   the density measured by the Coriolis meter; and
   the pressure differential measured by the Venturi meter,
to calculate the volume flow rate of fluid through the Venturi meter.

It is preferred that the Venturi meter is a wedge meter.

It is preferred that the flow of liquid is supplied by a centrifugal pump.

It is preferred that the apparatus further comprises a positive displacement pump and in which at least part of the liquid flows through the positive displacement pump.

It is preferred that the apparatus further comprises means to calculate the volume flow rate through the positive displacement pump, using:
the volume flow rate through the Venturi meter, and
the volume flow rate through the Coriolis meter,

It is preferred that the apparatus further comprises:
counting means for counting the pump strokes of the positive displacement pump;
calculating means for using the count of pump strokes to calculate the volume flow rate through the positive displacement pump; and
comparing means for comparing:
   the volume flow rate through the positive displacement pump as calculated by counting the pump strokes; with
   the volume flow rate through the positive displacement pump as calculated by using the volume flow rate through the Coriolis meter and the Venturi meter.

It is preferred that the liquid is a slurry. It is further preferred that the slurry is a drilling mud.

It will accordingly be appreciated that embodiments of the present invention provide apparatus and methods for the more accurate measurements of the volumetric flow and density of drilling mud.

### BRIEF DESCRIPTION OF THE DRAWINGS

So that the present invention may be more readily understood, preferred embodiments of it are described in conjunction with the accompanying drawings in which:

FIG. 1 is block schematic drawing of apparatus that is typically used in measuring the volumetric flow of drilling mud; and

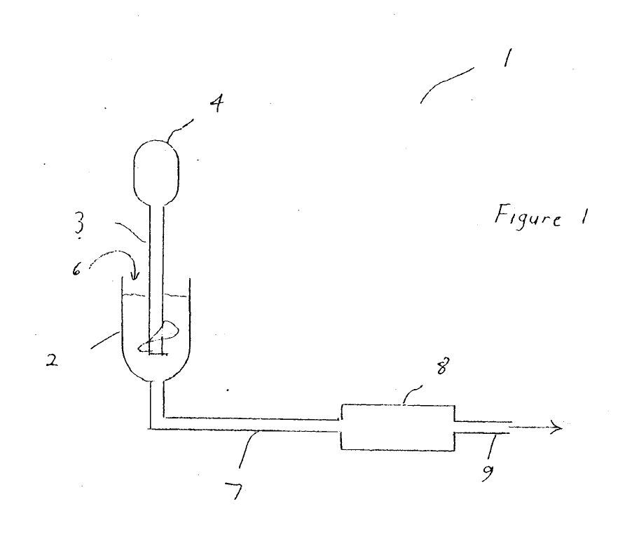

FIG. 2 is a block schematic drawing of apparatus according to preferred embodiments of the present invention.

### DESCRIPTION OF PREFERRED EMBODIMENTS OF THE INVENTION

Structure

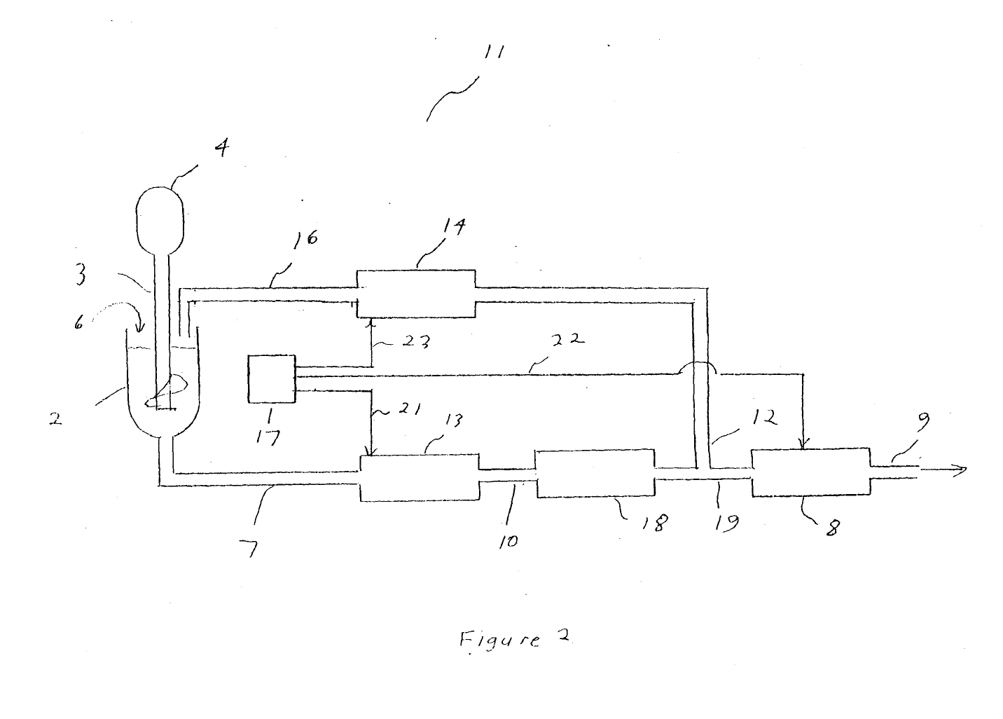

In the embodiment 11 of the invention that is illustrated in FIG. 2, a tank 2 for the supply of drilling mud 6 or the like is connected by pipe 7 to the input side of a pressure differential flow meter 13.

The output side of the pressure differential flow meter 13 is in turn connected through pipe 10 to the input of a charge pump 18. The preferred form of pump for the charge pump 18 is a centrifugal pump.

The output of the charge pump 18 is connected through a T-junction comprising pipes 19 and 12 to a positive displacement pump 8 and to a Coriolis meter 14 respectively. The preferred form of positive displacement pump is a piston pump. The Coriolis meter 14 is a type of meter that can be used to measure all of the density, the mass flow rate and the volumetric flow rate of liquid that is flowing through it. However, a Coriolis meter is not suitable for measuring the very high flows that are involved in the supply of drilling mud 6 to a drill hole.

The output of the positive displacement pump 8 is connected to pipe 9 for purposes which are described below. The output of the Coriolis meter 14 is connected to pipe 16 which connects as an input to the tank 2. A mixer 3 is mounted within the tank 2 and is driven by an electric motor 4.

Data and control lines 21, 22 and 23 interconnect a digital processor 17 with the pressure differential meter 13, the positive displacement pump 8 and the Coriolis meter 14 respectively. For purposes which are described below, control signals over the line 21 and 23 between the processor 17 and the meters 13 and 14 are according to the “HART Field Communication Protocol Specifications” which are available from HART Communication Foundation, 9390 Research Boulevard, Suite 1-350, Austin, Tex., USA.

Operation

The embodiment 11 of the invention that is illustrated in FIG. 2 utilizes a supply of drilling mud 6 in surface tanks 2 The mud 6 in the tank 2 is kept in a relatively homogeneous state using the mixer 3 which is driven by the electric motor 4. Operation of the charge pump 18 draws mud 6 off from tank 2 through pipe 7, through the pressure differential meter 13, through the charge pump 18, to the T-junction comprised by pipes 12 and 19. In flowing through the pressure differential meter 13, the mud 6 generates a pressure differential which is monitored by the digital processor 17.

The largest portion of the flow out of the charge pump 18 flows through pipe 19 into the input of the positive displacement pump 8 and from the output of the positive displacement pump into the bore hole (which is not illustrated in the drawings). A small portion of the flow out of the charge pump 18 flows through pipe 12 to the input of the Coriolis meter 14 and from the output of the Coriolis meter 14 through the pipe 16 back to the tank 2.

A pressure differential meter (or Venturi) meter relies on Bernoulli's equation, namely:

p+ρgh½ρv²=a constant
where
“p” is the pressure of a liquid;
“ρ” is the density of the liquid;
“g” is the acceleration due to gravity;
“h” is the height of the liquid; and
“v” is the velocity of the liquid.

However, as explained above, in the case of drilling mud the density “ρ” of the liquid varies and so it is necessary to know the (variable) density of the mud 6 that is flowing through the Venturi meter 13 in order to calculate the volumetric flow of mud 6 through that meter.

The Coriolis meter 14 accordingly takes a small proportion of the total flow of drilling mud 6 from the outlet of the charge pump 18 and measures the density and flow-rate of that small flow. The density of the mud 6 as measured by the Coriolis meter 14 is used, together with pressure differential across the wedge as measured in the Venturi meter 13, to calculate either or both of the mass flow rate and the density flow rate through the Venturi meter 13. According to some preferred embodiments of the invention, these calculations are performed by the digital processor 17. The digital processor 17 also compensates for differences in the times taken for mud 6 to flow from the tank 2 to each of:
the Venturi meter 13;
the positive displacement pump 8; and
the Coriolis meter 14.

The flow rate through the positive displacement pump 8 is equal to the (calculated) flow rate through the Venturi meter 13 minus the measured flow rate through the Coriolis meter 14. The digital processor 17 also calculates this flow rate.

The digital processor 17 also monitors the volumetric flow rate through the positive displacement pump 8 as calculated from counted pump strokes. This flow rate as measured by counting pump strokes should be the same as the calculated flow rate through the positive displacement pump 8. However, differences in:
flow as calculated by counting pump strokes; and
flow as calculated by the difference between flow through the Venturi meter and
flow through the Coriolis meter,

may indicate that maintenance is due on one or more of those meters. In particular, variations in these differences which show that the flow as calculated by measuring pump strokes is greater than the calculated flow through the positive displacement pump 8 is an indicator that the positive displacement pump 8 may be due for maintenance.

According to other, preferred embodiments of the invention which are not illustrated in the drawings, mud density as measured by the Coriolis meter 14 are passed directly to electronic circuitry that is associated with the Venturi meter 13.

The processor 17 monitors the density of the mud 6 to determine whether or not that density is reaching the range limit of the pressure differential meter 13 or the Coriolis metes 14. When the density reaches that limit, the processor uses the HART protocol to take the relevant meter 13 or 14 offline. The processor 17 suppresses any alarm which would show that the meter is offline or stopped and uploads new calibration data to that instrument. This new calibration data allows the instrument to handle a different density range. The processor 17 then puts the meter 13 or 14 back online.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

“Comprises/comprising” when used in this specification is taken to specify the presence of stated features, integers, steps or components but does not preclude the presence or addition of one or more other features, integers, steps, components or groups thereof. In the claims, each dependent claim is to be read as being within the scope of its parent claim or claims, in the sense that a dependent claim is not to be interpreted as infringed unless its parent claims are also infringed.

1. A method of measuring the volume flow rate of a liquid, comprising:
providing a flow of the liquid;
tapping off a portion of the flow of liquid and using a Coriolis meter to measure the density of that portion of the flow of liquid;
passing at least part of the flow of liquid through a Venturi meter; and
using the density of the liquid as measured by the Coriolis meter in calculating the volume flow rate of fluid through the Venturi meter.

2. A method as claimed in claim 1, in which the Venturi meter is a wedge meter.

3. A method as claimed in claim 1, in which the flow of liquid is supplied by a centrifugal pump.

4. A method as claimed in claim 1 in which at least part of the liquid flows through a positive displacement pump.

5. A method as claimed in claim 4, further comprising the step of using:
the volume flow rate through the Venturi meter, and
the volume flow rate through the Coriolis meter,
to calculate the volume flow rate through the positive displacement pump.

6. A method as claimed in claim 5, further comprising:
counting the pump strokes of the positive displacement pump;
using the count of pump strokes to calculate the volume flow rate through the positive displacement pump; and
comparing:
the volume flow rate through the positive displacement pump as calculated by counting the pump strokes;
with the volume flow rate through the positive displacement pump as calculated by using the volume flow rate through the Coriolis meter and the Venturi meter.

7. A method as claimed in claim 1, in which the liquid is a slurry.

8. A method as claimed in claim 7, in which the slurry is a drilling mud.

9. An apparatus for measuring the volume flow rate of a flow of liquid, comprising:
a Coriolis meter which is adapted to measure the density of a portion of the flow of liquid;
a Venturi meter which is adapted to measure a pressure differential which is generated by the flow of at least a portion of the liquid through it; and
means which is adapted to use:
the density measured by the Coriolis meter; and
the pressure differential measured by the Venturi meter, to calculate the volume flow rate of fluid through the Venturi meter.

10. The apparatus as claimed in claim 9, in which the Venturi meter is a wedge meter.

11. The apparatus as claimed in claim 9, in which the flow of liquid is supplied by a centrifugal pump.

12. The apparatus as claimed in claim 9, further comprising a positive displacement pump and in which at least part of the liquid flows through the positive displacement pump.

13. The apparatus as claimed in claim 12, further comprising means to calculate the volume flow rate through the positive displacement pump, using:
the volume flow rate through the Venturi meter, and the volume flow rate through the Coriolis meter.

14. The apparatus as claimed in claim 13, further comprising:
counting means for counting the pump strokes of the positive displacement pump;
calculating means for using the count of pump strokes to calculate the volume flow rate through the positive displacement pump; and
comparing means for comparing:
the volume flow rate through the positive displacement pump as calculated by counting the pump strokes; with
the volume flow rate through the positive displacement pump as calculated by using the volume flow rate through the Coriolis meter and the Venturi meter.

15. The apparatus as claimed in claim 9, in which the liquid is a slurry.

16. The apparatus as claimed in claim 15, in which the slurry is a drilling mud. 17-18. (cancelled)
